(19) United States
(12) Patent Application Publication
(10) Pub. No.: US 2023/0334911 A1
(43) Pub. Date: Oct. 19, 2023

(54) FACE LIVENESS DETECTION

(71) Applicant: NEC CORPORATION, Tokyo (JP)

(72) Inventor: Anusha V.S. BHAMIDIPATI, Tokyo (JP)

(21) Appl. No.: 17/720,225

(22) Filed: Apr. 13, 2022

(51) Int. Cl. G06V 40/40; G06V 40/16; G06F 21/32; G06T 7/50; H04R 3/12; G06V 10/82

(52) U.S. Cl. CPC G06V 40/40; G06F 21/32; G06T 7/50; G06V 10/82; G06V 40/172; H04R 3/12; G06T 2207/10132

(57) ABSTRACT

Face liveness is detected by emitting an ultra-high frequency (UHF) sound signal through a speaker, obtaining an echo signal by detecting reflections of the UHF sound signal off of a surface with a plurality of sound detectors, extracting a plurality of feature values from the echo signal, and applying a classifier to the plurality of feature values to determine whether the surface is a live face.

### BACKGROUND

Face recognition systems are utilized to prevent unauthorized access to devices and services. The integrity of face recognition systems has been challenged by unauthorized personnel seeking to gain access to protected devices and services. Recently, mobile devices, such as smartphones, are utilizing face recognition to prevent unauthorized access to the mobile device.

As a result of the increase in popularity of face recognition systems in mobile devices, mobile devices are becoming targeted more and more by face presentation attacks, because the use of face authentication is an increasingly utilized method for unlocking mobile devices, such as smartphones. Face presentation attacks include 2D print attacks, which uses an image of the authorized user’s face, replay attacks, which use a video of the authorized user’s face, and, more recently, 3D mask attacks, which use a 3D printed mask of the authorized user’s face.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a top view of a schematic diagram of an apparatus for face liveness detection, according to at least some embodiments of the subject disclosure.

FIG. 1B is a front view of a schematic diagram of an apparatus for face liveness detection, according to at least some embodiments of the subject disclosure.

FIG. 1C is a bottom view of a schematic diagram of an apparatus for face liveness detection, according to at least some embodiments of the subject disclosure.

FIG. 2 is an operational flow for face recognition to prevent unauthorized access, according to at least some embodiments of the subject disclosure.

FIG. 3 is an operational flow for face liveness detection, according to at least some embodiments of the subject disclosure.

FIG. 4 is an operational flow for echo signal obtaining, according to at least some embodiments of the subject disclosure.

FIG. 5 is an operational flow for a first feature value extraction and classifier application process, according to at least some embodiments of the subject disclosure.

FIG. 6 is an operational flow for training a neural network for feature extraction, according to at least some embodiments of the subject disclosure.

FIG. 7 is an operational flow for a second feature value extraction and classifier application process, according to at least some embodiments of the subject disclosure.

FIG. 8 is a schematic diagram of a third feature value extraction and classifier application process, according to at least some embodiments of the subject disclosure.

FIG. 9 is a block diagram of a hardware configuration for face liveness detection, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

There are some echo-based methods that successfully detect 2D print and replay attacks. However, existing echo-based methods are still vulnerable to 3D mask attacks. For example, there are echo-based methods that use radar transmitter and receiver signal features along with visual features for face liveness detection, and also methods that use echo and visual landmark features for face authentication.

Such echo-based methods use sound signals in the range of 12 kHz -20 kHz, and which are audible to most users, creating user inconvenience. Such echo-based methods capture an echo signal using only a single microphone usually on either a top or a bottom of the device, which yields lower resolution face depth. Such echo-based methods are routinely compromised by 3D mask attacks.

At least some embodiments described herein utilize an Ultra High Frequency (UHF) echo-based method for passive mobile liveness detection. At least some embodiments described herein include echo-based methods of increased robustness through use of features commonly found in handheld devices. At least some embodiments described herein analyze echo signals to extract more features to detect 3D mask attacks.

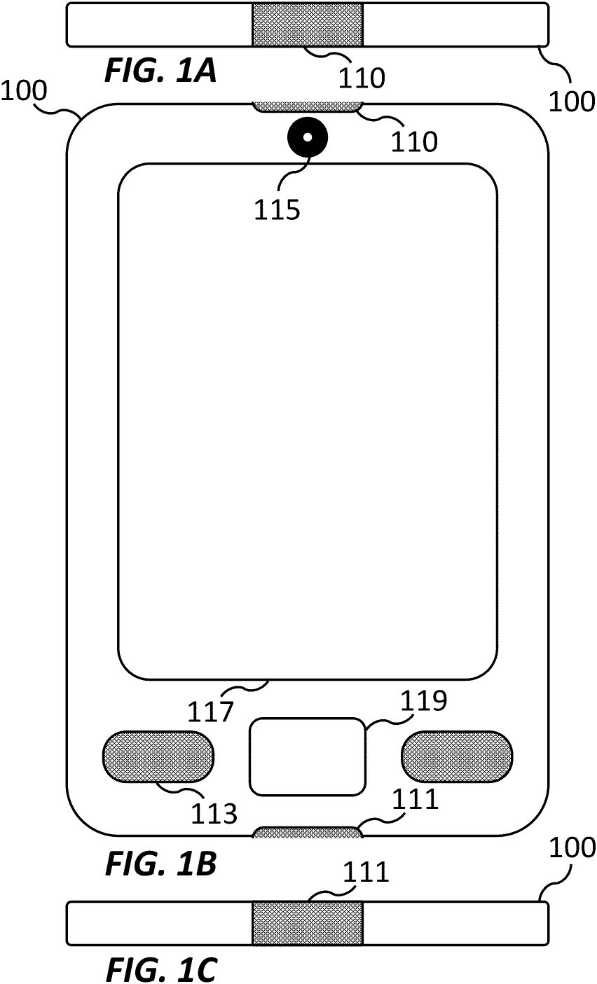

FIGS. 1A, 1B, and 1C are a schematic diagram of an apparatus 100 for face liveness detection, according to at least some embodiments of the subject disclosure. Apparatus 100 includes a microphone 110, a microphone 111, a speaker 113, a camera 115, a display 117, and an input 119. FIG. 1B is a front view of a schematic diagram of apparatus 100, according to at least some embodiments of the subject disclosure, and shows the aforementioned components. In at least some embodiments, apparatus 100 is within a handheld device, such that speaker 113 and plurality of microphones 110 and 111 are included in the handheld device.

In at least some embodiments, an apparatus for face liveness detection includes a plurality of sound detectors. In at least some embodiments, the plurality of sound detectors includes a plurality of microphones, such as microphones 110 and 111. In at least some embodiments, microphones 110 and 111 are configured to convert audio signals into electrical signals. In at least some embodiments, microphones 110 and 111 are configured to convert audio signals into signals of other forms of energy that are further processable. In at least some embodiments, microphones 110 and 111 are transducers. In at least some embodiments, microphones 110 and 111 are compression microphones, dynamic microphones, etc., in any combination. In at least some embodiments, microphones 110 and 111 are further configured to detect audible signals, such as for calls, voice recording, etc.

In at least some embodiments, the plurality of sound detectors includes a first sound detector oriented in a first direction and a second sound detector oriented in a second direction. Microphones 110 and 111 are oriented to receive audio signals from different directions. Microphone 110 is located on the top side of apparatus 100. FIG. 1A is a top view of a schematic diagram of apparatus 100, according to at least some embodiments of the subject disclosure, and shows microphone 110 opening upward. Microphone 111 is located on the bottom side of apparatus 100. FIG. 1C is a bottom view of a schematic diagram of apparatus 100, according to at least some embodiments of the subject disclosure, and shows microphone 110 opening downward. In at least some embodiments, the sound detectors are oriented in other directions, such as right and left sides, oblique angles, or any combination as long as the angles of sound reception are different. In at least some embodiments, a reflection pattern of an echo signal captured by both microphones of different orientation along with acoustic absorption and backscatter information are utilized to detect 2D and 3D face presentation attacks. In at least some embodiments, the use of microphones of different orientation for capturing of UHF signal reflection helps to isolate the echo signal through template matching, and improves signal-to-noise ratio. In at least some embodiments, the plurality of sound detectors includes more than two detectors.

Speaker 113 is located on the front of apparatus 100. In at least some embodiments, speaker 113 is configured to emit UHF signals. In at least some embodiments, speaker 113 is configured to emit UHF signals. In at least some embodiments, speaker 113 is a loudspeaker, a piezoelectric speaker, etc. In at least some embodiments, speaker 113 is configured to emit UHF signals in substantially the same direction as an optical axis of camera 115, so that the UHF signals reflect off a surface being imaged by camera 115. In at least some embodiments, speaker 113 is a transducer configured to convert electrical signals into audio signals. In at least some embodiments, speaker 113 is further configured to emit audible signals, such as for video and music playback.

In at least some embodiments, the handheld device further includes camera 115. In at least some embodiments, camera 115 is configured to image objects in front of apparatus 100, such as a face of a user holding apparatus 100. In at least some embodiments, camera 115 includes an image sensor configured to convert visible light signals into electrical signals or any other further processable signals.

Display 117 is located on the front of apparatus 100. In at least some embodiments, display 117 is configured to produce a visible image, such as a graphical user interface. In at least some embodiments, display 117 includes a Liquid Crystal Display (LCD), a Light Emitting Diode (LED) array, or any other display technology fit for a handheld device. In at least some embodiments, display 117 is touch sensitive, such as a touchscreen, and is further configured to receive tactile input. In at least some embodiments, display 117 is configured to show an image currently being captured by camera 115 to assist the user in pointing the camera at the user’s face.

Input 119 is located on the front of apparatus 100. In at least some embodiments, input 119 is configured to receive tactile input. In at least some embodiments, input 119 is a button, a pressure sensor, a fingerprint sensor, or any other form of tactile input, including combinations thereof.

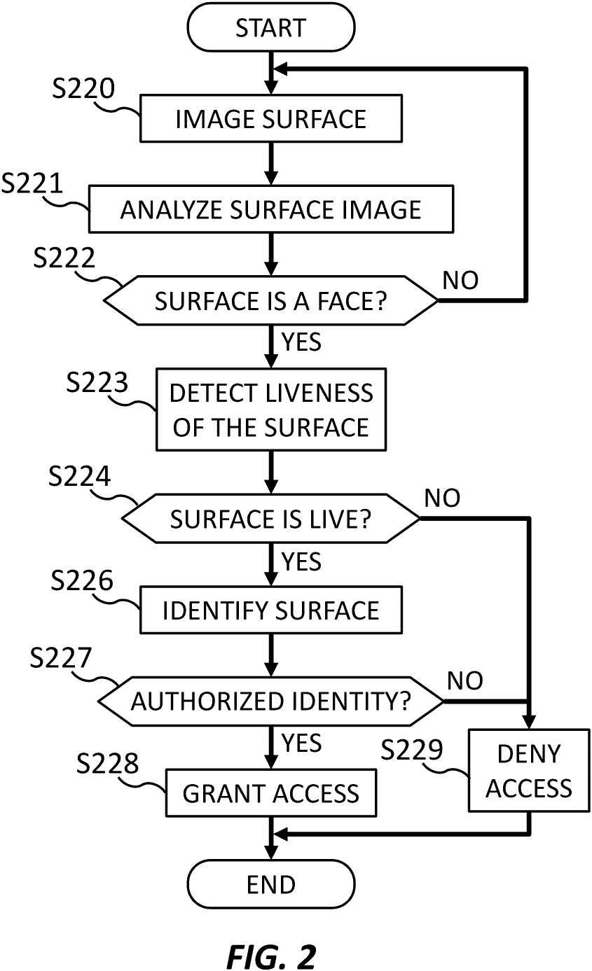

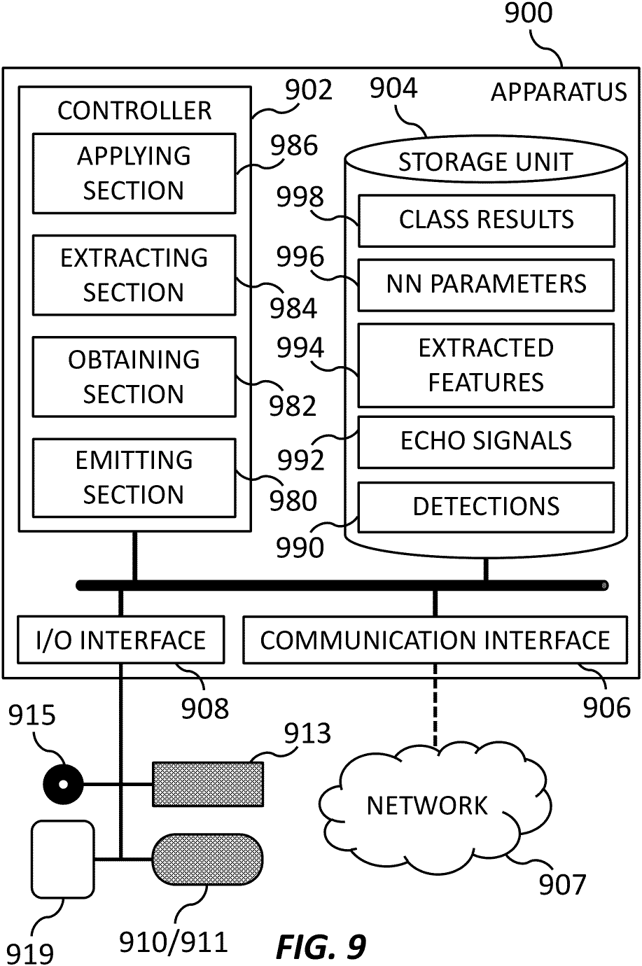

FIG. 2 is an operational flow for face recognition to prevent unauthorized access, according to at least some embodiments of the subject disclosure. The operational flow provides a method of face recognition to prevent unauthorized access. In at least some embodiments, one or more operations of the method are executed by a controller of an apparatus including sections for performing certain operations, such as the controller and apparatus shown in FIG. 9, which will be explained hereinafter.

At S220, the controller or a section thereof images a surface. In at least some embodiments, the controller images the surface with a camera to obtain a surface image. In at least some embodiments, the controller images a face of a user of a handheld device, such as apparatus 100 of FIG. 1. In at least some embodiments, the controller images the surface to produce a digital image for image processing.

At S221, the controller or a section thereof analyzes the surface image. In at least some embodiments, the controller analyzes the surface image to determine whether the surface is a face. In at least some embodiments, the controller analyzes the image of the surface to detect facial features, such as eyes, nose, mouth, ears, etc., for further analysis. In at least some embodiments, the controller rotates, crops, or performs other spatial manipulations to normalize facial features for face recognition.

At S222, the controller or a section thereof determines whether the surface is a face. In at least some embodiments, the controller determines whether the surface is a face based on the surface image analysis at S221. If the controller determines that the surface is a face, then the operational flow proceeds to liveness detection at S223. If the controller determines that the surface is not a face, then the operational flow returns to surface imaging at S220.

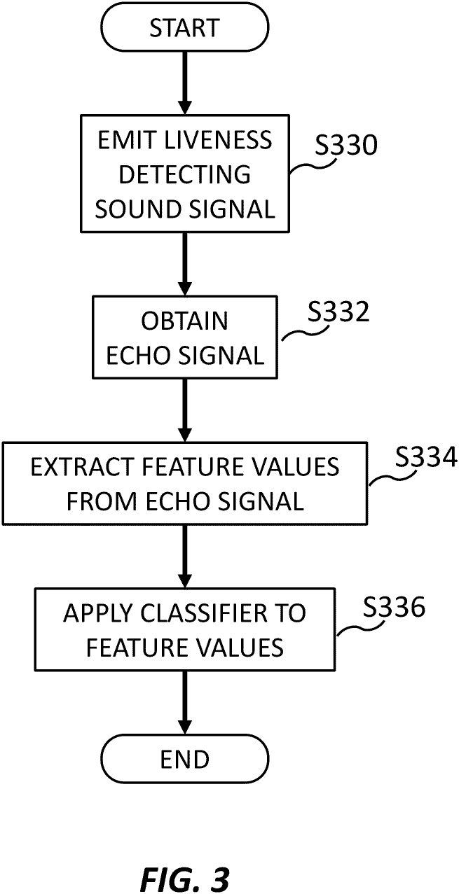

At S223, the controller or a section thereof detects liveness of the surface. In at least some embodiments, the controller detects 2D and 3D face presentation attacks. In at least some embodiments, the controller performs the liveness detection process described hereinafter with respect to FIG. 3.

At S224, the controller or a section thereof determines whether the surface is live. In at least some embodiments, the controller determines whether the surface is a live human face based on the liveness detection at S223. If the controller determines that the surface is live, then the operational flow proceeds to surface identification at S226. If the controller determines that the surface is not live, then the operational flow proceeds to access denial at S229.

At S226, the controller or a section thereof identifies the surface. In at least some embodiments, the controller applies a face recognition algorithm, such as a comparison of geometric or photo-metric features of the surface with that of faces of known identity. In at least some embodiments, the controller obtains a distance measurement between deep features of the surface and deep features of each face of known identity, and identifies the surface based on the shortest distance. In at least some embodiments, the controller identifies the surface by analyzing the surface image in response to determining that the surface is a face and determining that the surface is a live face.

At S227, the controller or a section thereof determines whether the identity is authorized. In at least some embodiments, the controller determines whether a user identified at S226 is authorized for access. If the controller determines that the identity is authorized, then the operational flow proceeds to access granting at S228. If the controller determines that the identity is not authorized, then the operational flow proceeds to access denial at S229.

At S228, the controller or a section thereof grants access. In at least some embodiments, the controller grants access to at least one of a device or a service in response to identifying the surface as an authorized user. In at least some embodiments, the controller grants access to at least one of a device or a service in response to not identifying the surface as an unauthorized user. In at least some embodiments, the device of which access is granted is the apparatus, such as the handheld device of FIG. 1. In at least some embodiments, the service is a program or application executed by the apparatus.

At S229, the controller or a section thereof denies access. In at least some embodiments, the controller denies access to the at least one device or service in response to not identifying the surface as an authorized user. In at least some embodiments, the controller denies access to the at least one device or service in response to identifying the surface as an unauthorized user.

In at least some embodiments, the controller performs the operations in a different order. In at least some embodiments, the controller detects liveness before analyzing the surface image or even before imaging the surface. In at least some embodiments, the controller detects liveness after identifying the surface and even after determining whether the identity is authorized. In at least some embodiments, the operational flow is repeated after access denial, but only for a predetermined number of access denials until enforcement of a wait time, powering down of the apparatus, self-destruction of the apparatus, requirement further action, etc.

FIG. 3 is an operational flow for face liveness detection, according to at least some embodiments of the subject disclosure. The operational flow provides a method of face liveness detection. In at least some embodiments, one or more operations of the method are executed by a controller of an apparatus including sections for performing certain operations, such as the controller and apparatus shown in FIG. 9, which will be explained hereinafter.

At S330, an emitting section emits a liveness detecting sound signal. In at least some embodiments, the emitting section emits an ultra-high frequency (UHF) sound signal through a speaker. In at least some embodiments, the emitting section emits the UHF sound signal in response to detecting a face with the camera. In at least some embodiments, the emitting section emits the UHF sound signal in response to identifying the face.

In at least some embodiments, the emitting section emits the UHF sound signal as substantially inaudible. A substantially inaudible sound signal is a sound signal that most people will not be able to hear or will not consciously notice. The amount of people to which the sound signal will be inaudible increases as the frequency of the sound signal increases. In at least some embodiments, the emitting section emits the UHF sound signal at 18-22 kHz. The wave form of the sound signal also affects the amount of people to which the sound signal will be inaudible. In at least some embodiments, the emitting section emits the UHF sound signal including a sinusoidal wave and a sawtooth wave. In at least some embodiments, the emitting section emits a UHF sound signal that is a combination of sinusoidal and saw tooth waves in the range of 18-22 kHz through mobile phone to illuminate the user’s face.

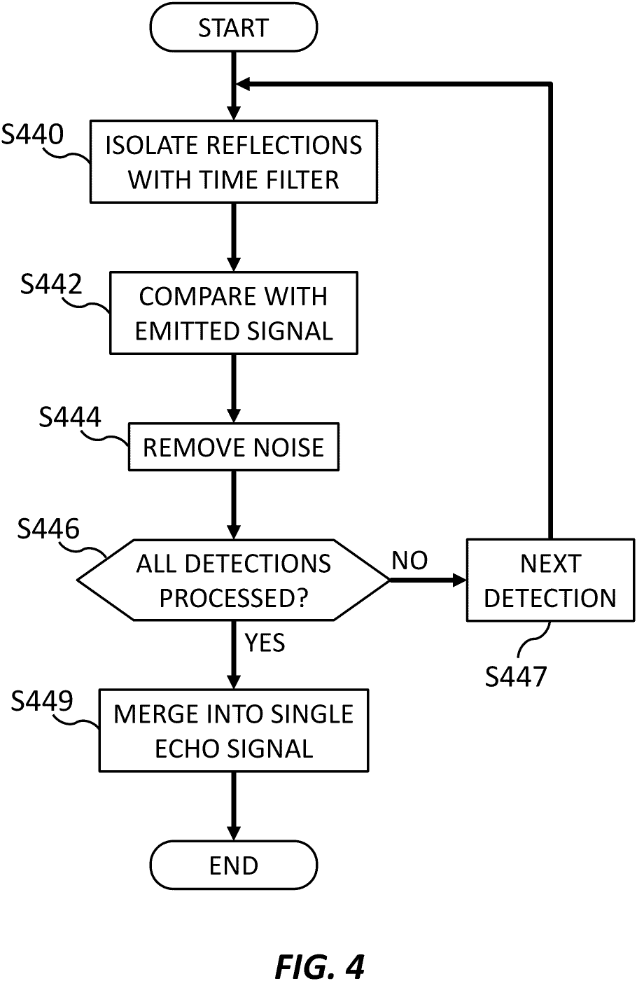

At S332, an obtaining section obtains an echo signal. In at least some embodiments, the obtaining section obtains an echo signal by detecting reflections of the UHF sound signal off of a surface with a plurality of sound detectors. In at least some embodiments, the obtaining section converts raw recordings of the plurality of sound detectors into a single signal representative of one or more echoes of the emitted sound signal from the surface. In at least some embodiments, the obtaining section performs the echo signal obtaining process described hereinafter with respect to FIG. 4.

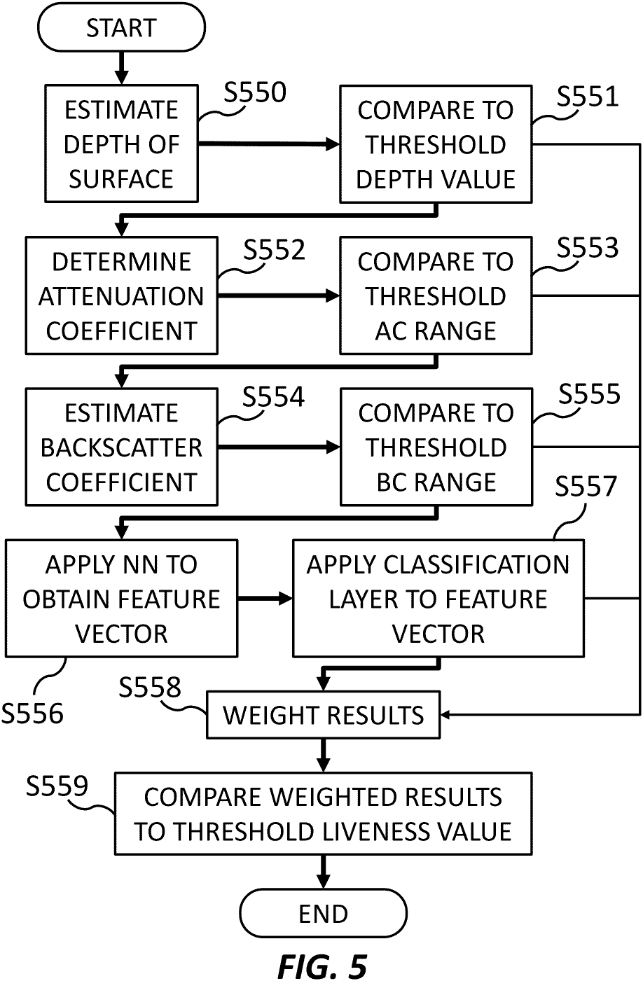

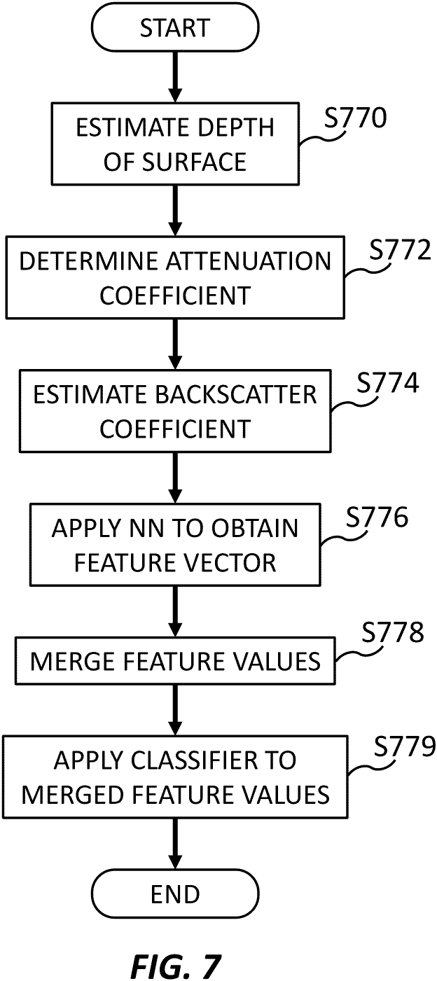

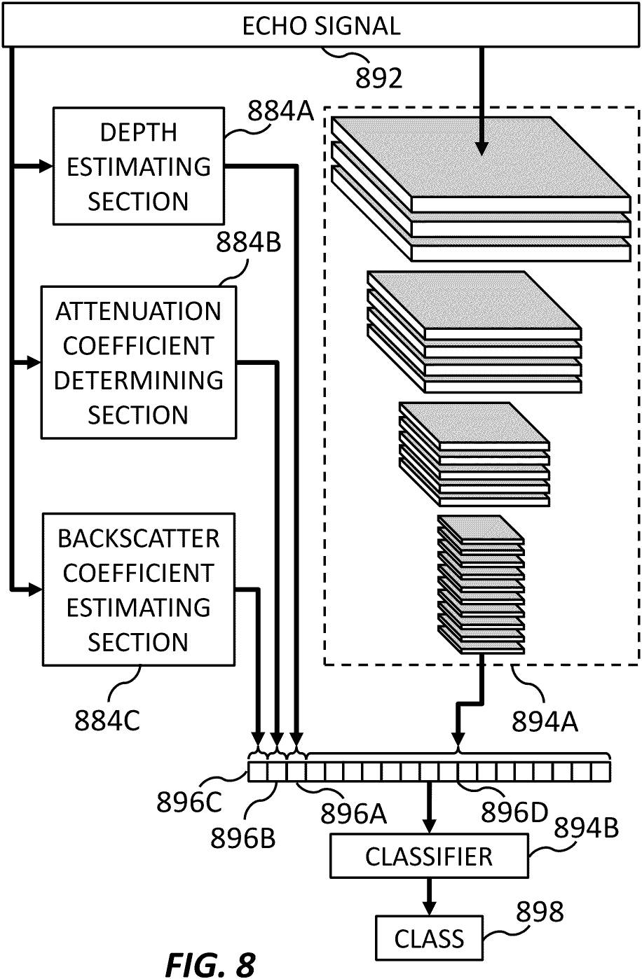

At S334, an extracting section extracts feature values from the echo signal. In at least some embodiments, the extracting section extracts a plurality of feature values from the echo signal. In at least some embodiments, the extracting section extracts hand-crafted feature values from the echo signal, such as by using formulae to calculate specific properties. In at least some embodiments, the extracting section applies one or more neural networks to the echo signal to extract compressed feature representations. In at least some embodiments, the extracting section performs the feature value extraction process described hereinafter with respect to FIG. 5, FIG. 7, or FIG. 8.

At S336, an applying section applies a classifier to the feature values. In at least some embodiments, the applying section applying a classifier to the plurality of feature values to determine whether the surface is a live face. In at least some embodiments, the applying section applies a threshold to each feature value to make a binary classification of the feature value as consistent or inconsistent with a live human face. In at least some embodiments, the applying section applies a neural network classifier to a concatenation of the feature values to produce a binary classification of the feature value as consistent or inconsistent with a live human face. In at least some embodiments, the applying section performs the classifier application process described hereinafter with respect to FIG. 5, FIG. 7, or FIG. 8.

FIG. 4 is an operational flow for echo signal obtaining, according to at least some embodiments of the subject disclosure. The operational flow provides a method of echo signal obtaining. In at least some embodiments, one or more operations of the method are executed by an obtaining section of an apparatus, such as the apparatus shown in FIG. 9, which will be explained hereinafter. In at least some embodiments, operations S440, S442, and S444 are performed on a sound detection from each sound detector of the apparatus in succession, each sound detection including echo signals and/or reflected sound signals captured by the respective sound detector.

At S440, the obtaining section or a sub-section thereof isolates reflections with a time filter. In at least some embodiments, the obtaining section isolates the reflections of the UHF sound signal with a time filter. In at least some embodiments, the obtaining section dismisses, discards, or ignores data of the detection outside of a predetermined time frame measured from the time of sound signal emission. In at least some embodiments, the predetermined time frame is calculated to include echo reflections based on an assumption that the surface is at a distance of 25-50 cm from the apparatus, which is a typical distance of a user’s face from a handheld device when pointing a camera of the device at their own face.

At S442, the obtaining section or a sub-section thereof compares the sound detection with the emitted sound signal. In at least some embodiments, as iterations proceed the obtaining section compares detections of each sound detector of the plurality of sound detectors and the emitted UHF sound signal. In at least some embodiments, the obtaining section performs template matching to discern echoes from noise in the detection.

At S444, the obtaining section or a sub-section thereof removes noise from the sound detection. In at least some embodiments, the obtaining section removes noise from the reflections of the UHF sound signal. In at least some embodiments, the obtaining section removes the noise discerned from the echoes at S442.

At S446, the obtaining section or a sub-section thereof determines whether all detections have been processed. If the obtaining section determines that unprocessed detections remain, then the operational flow returns to reflection isolation at S440. If the obtaining section determines that all detections have been processed, then the operational flow proceeds to merging at S449.

At S449, the obtaining section or a sub-section thereof merges the remaining data of each sound detection into a single echo signal. In at least some embodiments, the obtaining section sums the remaining data of each sound detection. In at least some embodiments, the obtaining section offsets remaining data of each sound detection based on relative distance from the surface before summing. In at least some embodiments, the obtaining section applies a further noise removal process after merging. In at least some embodiments, the obtaining section merges the remaining data of each sound detection such that the resulting signal-to-noise ratio is greater than the signal-to-noise ratio of the individual sound detections. In at least some embodiments, the obtaining section detects time shift or lag among the sound detections to increase the resulting signal-to-noise ratio. In at least some embodiments, the obtaining section obtains a cross-correlation among the sound detections to determine the time frame of maximum correlation among the sound detections, shifts the timing of each sound detection according to match the determined time frame of maximum correlation, and sums the sound detections.

FIG. 5 is an operational flow for a first feature value extraction and classifier application process, according to at least some embodiments of the subject disclosure. The operational flow provides a first method of feature value extraction and classifier application. In at least some embodiments, one or more operations of the method are executed by an extracting section and an applying section of an apparatus, such as the apparatus shown in FIG. 9, which will be explained hereinafter.

At S550, the extracting section or a sub-section thereof estimates a depth of a surface from the echo signal. In at least some embodiments, extracting the plurality of feature values from the echo signal includes estimating a depth of the surface from the echo signal. In at least some embodiments, the extracting section performs a pseudo depth estimation. In at least some embodiments, the extracting section estimates the depth of the surface according to the difference between the distance according to the first reflection and the distance according to the last reflection. In at least some embodiments, the distance is calculated as half of the amount of delay between emission of the UHF sound signal and detection of the reflection multiplied by the speed of sound. In at least some embodiments, the depth D is calculated according to the following equation:

$$D = \frac{{V}_{s} \left[\left({t}_{l} - {t}_{e}\right) - \left({t}_{f} - {t}_{e}\right)\right]}{2} \qquad \text{EQ. 1}$$

where Vₛ is the speed of sound, tₗ is the time at which the latest reflection was detected, t_{f} is the time the first reflection was detected, and tₑ is the time the UHF sound signal was emitted.

At S551, the applying section or a sub-section thereof compares the estimated depth to a threshold depth value. In at least some embodiments, applying the classifier includes comparing the depth to a threshold depth value. In at least some embodiments, the applying section determines that the estimated depth is consistent with a live human face in response to the estimated depth being greater than the threshold depth value. In at least some embodiments, the applying section determines that the estimated depth is inconsistent with a live human face in response to the estimated depth being less than or equal to the threshold depth value. In at least some embodiments, the threshold depth value is a parameter that is adjustable by an administrator of the face detection system. In at least some embodiments, the threshold depth value is small, because the depth estimation is only to prevent 2D attacks. In at least some embodiments, where depths of all the latest reflections compared to the depth of the first reflection are the same, the applying section concludes that the surface is a planar 2D surface.

At S552, the extracting section or a sub-section thereof determines an attenuation coefficient of the surface from the echo signal. In at least some embodiments, extracting the plurality of feature values from the echo signal includes determining an attenuation coefficient of the surface from the echo signal. As the emitted UHF sound signal hits various surfaces, the signal gets absorbed, reflected and scattered. In particular, signal absorption and scattering leads to signal attenuation. Different material properties lead to different amounts of signal attenuation. In at least some embodiments, the extracting section utilizes the following equation to determine the attenuation coefficient:

$$A \left(z , f\right) = {A}_{0} {e}^{- \frac{{α}_{f z}}{8.7}} \qquad \text{EQ. 2}$$

where A(z,f) is the amplitude of the echo (attenuated) signal, A₀ is the amplitude of the emitted UHF sound signal, and α is the absorption coefficient, which varies depending on objects and materials. In at least some embodiments, the attenuation coefficient is used alone to differentiate 3D masks from live faces, because the material of 3D masks and live faces yield different attenuation coefficients.

At S553, the applying section or a sub-section thereof compares the determined attenuation coefficient to a threshold attenuation coefficient range. In at least some embodiments, applying the classifier includes comparing the attenuation coefficient to a threshold attenuation coefficient range. In at least some embodiments, the applying section determines that the determined attenuation coefficient is consistent with a live human face in response to the determined attenuation coefficient being within the threshold attenuation coefficient range. In at least some embodiments, the applying section determines that the determined attenuation coefficient is inconsistent with a live human face in response to the determined attenuation coefficient not being within the threshold attenuation coefficient range. In at least some embodiments, the threshold attenuation coefficient range includes parameters that are adjustable by an administrator of the face detection system. In at least some embodiments, the threshold attenuation coefficient range is small, because attenuation coefficients of live human faces have little variance.

At S554, the extracting section or a sub-section thereof estimates a backscatter coefficient of the surface from the echo signal. In at least some embodiments, extracting the plurality of feature values from the echo signal includes estimating a backscatter coefficient of the surface from the echo signal. The echo signal has backscatter characteristics that vary depending on the material from which it was reflected. In at least some embodiments, the extracting section estimates the backscatter coefficient to classify whether the input is 3D mask or real face. “Backscatter coefficient” is a parameter that describes the effectiveness with which the object scatters ultrasound energy. In at least some embodiments, the backscatter coefficient η(w) is obtained from two measurements, the power spectra of the backscatter signal, and the power spectra of the reflected signal from a flat reference surface, which is previously obtained from a calibration process. A normalized backscatter signal power spectrum for a signal can be given as:

$$\overline{S} \left(k\right) = \frac{{γ}^{2}}{L} {\sum }_{l = 0}^{L - 1} \frac{{S}_{l} \left(k\right)}{{S}_{r e f} \left(k\right)} α \left(k\right) \qquad \text{EQ. 3}$$

where Sₗ(k) is the windowed short-time Fourier transform of the lth scan line segment, S_{ref}(k) is the windowed short-time Fourier transform of the backscattered signal from a reflector with reflection coefficient γ, α(k) is a function that compensates for attenuation, and L is the number of scan line segments included in the data block. The power spectrum for a reflected signal from a reference surface Sᵣ(k) is similarly calculated. The backscatter coefficient η(w) is then calculated as:

$$η \left(w\right) = \frac{\overline{S} \left(k\right)}{{S}_{r} \left(k\right)} {ε}^{4} \qquad \text{EQ. 4}$$

where

$${ε}^{4} = {\left(\frac{2 \sqrt{ρ c ⋅ {ρ}_{0} {c}_{0}}}{ρ c + {ρ}_{0} {c}_{0}}\right)}^{4} = \frac{16 {\left(ρ c / {ρ}_{0} {c}_{0}\right)}^{2}}{{\left(1 + ρ c / {ρ}_{0} {c}_{0}\right)}^{4}} \qquad \text{EQ. 5}$$

where ε⁴ represents the transmission loss, ρ₀c₀ is the acoustic impedance of the medium, and ρc is the acoustic impedance of the surface.

At S555, the applying section or a sub-section thereof compares the estimated backscatter coefficient to a threshold backscatter coefficient range. In at least some embodiments, applying the classifier includes comparing the backscatter coefficient to a threshold backscatter coefficient range. In at least some embodiments, the applying section determines that the estimated backscatter coefficient is consistent with a live human face in response to the estimated backscatter coefficient being within the threshold backscatter coefficient range. In at least some embodiments, the applying section determines that the estimated backscatter coefficient is inconsistent with a live human face in response to the estimated backscatter coefficient not being within the threshold backscatter coefficient range. In at least some embodiments, the threshold backscatter coefficient range includes parameters that are adjustable by an administrator of the face detection system. In at least some embodiments, the threshold backscatter coefficient range is small, because backscatter coefficients of live human faces have little variance.

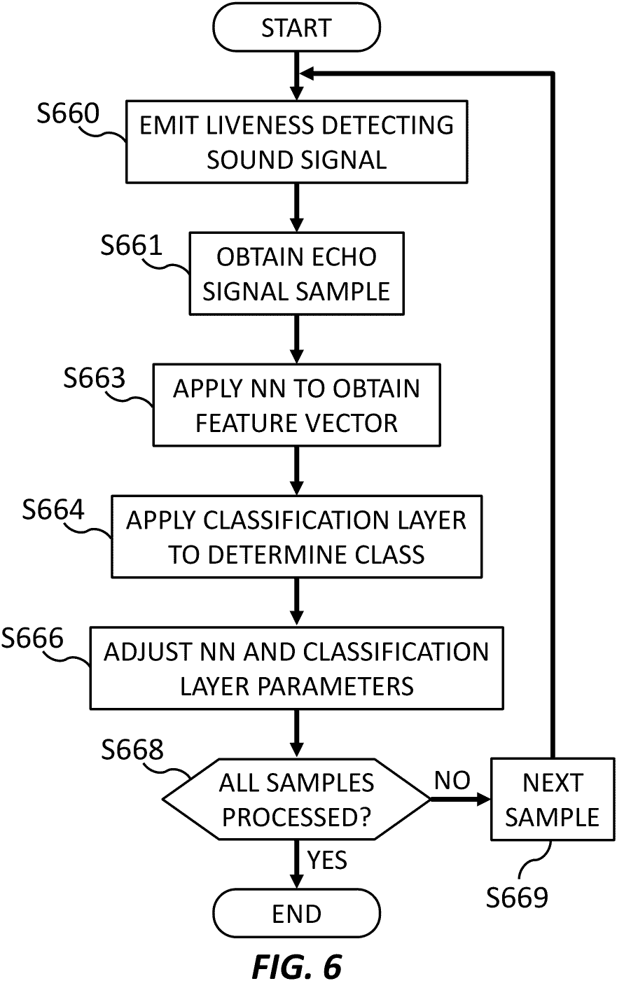

At S556, the extracting section or a sub-section thereof applies a neural network to the echo signal to obtain a feature vector. In at least some embodiments, extracting the plurality of feature values from the echo signal includes applying a neural network to the echo signal to obtain a feature vector, the neural network trained with a classification layer to classify echo signal samples as live or not live. In at least some embodiments, the extracting section applies a convolutional neural network to the echo signal to obtain a deep feature vector. In at least some embodiments, the neural network is trained to output feature vectors upon application to echo signals. In at least some embodiments, the neural network undergoes the training process described hereinafter with respect to FIG. 6.

At S557, the applying section or a sub-section thereof applies a classification layer to the feature vector. In at least some embodiments, applying the classifier includes applying the classification layer to the feature vector. In at least some embodiments, the applying section determines that the echo signal is consistent with a live human face in response to a first output value from the classification layer. In at least some embodiments, the applying section determines that the echo signal is inconsistent with a live human face in response to a second output value from the classification layer. In at least some embodiments, the classification layer is an anomaly detection classifier. In at least some embodiments, the classification layer is trained to output binary values upon application to feature vectors, the binary value representing whether the echo signal is consistent with a live human face. In at least some embodiments, the classification layer undergoes the training process described hereinafter with respect to FIG. 6.

At S558, the applying section or a sub-section thereof weights the results of whether each feature is consistent with a live human face. In at least some embodiments, the applying section applies a weight to each result in proportion to the strength of the feature as a determining factor in whether or not the surface is a live face. In at least some embodiments, the weights are parameters that are adjustable by an administrator of the face recognition system. In at least some embodiments, the weights are trainable parameters.

At S559, the applying section compares the weighted results to a threshold liveness value. In at least some embodiments, the weighted results are summed and compared to a single threshold liveness value. In at least some embodiments, the weighted results undergo a more complex calculation before comparison to the threshold liveness value. In at least some embodiments, the feature vector obtained from a CNN (Convolutional Neural Network) is combined with the handcrafted features to obtain the final scores to determine whether the surface is a live human face. In at least some embodiments, the applying section determines that the surface is a live human face in response to the sum of weighted results being greater than the threshold liveness value. In at least some embodiments, the applying section determines that the surface is not a live human face in response to the sum of weighted results being less than or equal to the threshold liveness value.

FIG. 6 is an operational flow for training a neural network for feature extraction, according to at least some embodiments of the subject disclosure. The operational flow provides a method of training a neural network for feature extraction. In at least some embodiments, one or more operations of the method are executed by a controller of an apparatus, such as the apparatus shown in FIG. 9, which will be explained hereinafter.

At S660, an emitting section emits a liveness detecting sound signal. In at least some embodiments, the emitting section emits an ultra-high frequency (UHF) sound signal through a speaker. In at least some embodiments, the emitting section emits the liveness detecting sound signal in the same manner as in S330 during the liveness detection process of FIG. 3. In at least some embodiments, the emitting section emits the liveness detecting sound signal toward a surface that is known to be a live human face or a surface that is not, such as a 3D mask, a 2D print, or a screen showing a replay attack.

At S661, an obtaining section obtains an echo signal sample. In at least some embodiments, the obtaining section obtains an echo signal sample by detecting reflections of the UHF sound signal off of a surface with a plurality of sound detectors. In at least some embodiments, the obtaining section obtains the echo signal sample in the same manner is in S332 during the liveness detection process of FIG. 3. In at least some embodiments, the captured and processed echo signal is used to train a one class classifier to obtain CNN (Convolutional Neural Network) features for real faces such that any distribution other than real faces is considered an anomaly and is classified as not real.

At S663, an extracting section applies the neural network to obtain the feature vector. In at least some embodiments, the extracting section applies the neural network to the echo signal sample to obtain the feature vector. In the first iteration of neural network application at S663, the neural network is initialized as random values in at least some embodiments. As such, the obtained feature vector may not be very determinative of liveness. As iterations proceed, weights of the neural network are adjusted, and the obtained feature vector becomes more determinative of liveness.

At S664, the application section applies a classification layer to the feature vector in order to determine the class of the surface. In at least some embodiments, the classification layer is a binary classifier that yields either a class indicating that the feature vector is consistent with a live human face or a class indicating that the feature vector is inconsistent with a live human face.

At S666, the applying section adjusts parameters of the neural network and the classification layer. In at least some embodiments, the applying section adjusts weights of the neural network and the classification layer according to a loss function based on whether the class determined by the classification layer at S664 is correct in view of the known information about whether the surface is a live human face or not. In at least some embodiments, the training includes adjusting parameters of the neural network and the classification layer based on a comparison of output class with corresponding labels. In at least some embodiments, gradients of the weights are calculated from the output layer of the classification layer back through the neural network though a process of backpropagation, and the weights are updated according to the newly calculated gradients. In at least some embodiments, the parameters of the neural network are not adjusted after every iteration of the operations at S663 and S664. In at least some embodiments, as iterations proceed, the controller training the neural network with the classification layer using a plurality of echo signals samples, each echo signal sample labeled live or not live.

At S668, the controller or a section thereof determines whether all echo signal samples have been processed. In at least some embodiments, the controller determines that all samples have been processed in response to a batch of echo signal samples being entirely processed or in response to some other termination condition, such as neural network converging on a solution, a loss value of the loss function falling below a threshold value, etc. If the controller determines that unprocessed echo signal samples remain, or that another termination condition has not yet been met, then the operational flow returns to signal emission at S660 for the next sample (S669). If the controller determines that all echo signal samples have been processed, or that another termination condition has been met, then the operational flow ends.

In at least some embodiments, the signal emission at S660 and echo signal obtaining at S661 are performed for a batch of samples before proceeding to iterations of the operations at S663, S664 and S666.

FIG. 7 is an operational flow for a second feature value extraction and classifier application process, according to at least some embodiments of the subject disclosure. The operational flow provides a second method of feature value extraction and classifier application. In at least some embodiments, one or more operations of the method are executed by an extracting section and an applying section of an apparatus, such as the apparatus shown in FIG. 9, which will be explained hereinafter.

At S770, the extracting section or a sub-section thereof estimates a depth of a surface from the echo signal. Depth estimation at S770 is substantially similar to depth estimation at S550 of FIG. 5 except where described differently.

At S772, the extracting section or a sub-section thereof determines an attenuation coefficient of the surface from the echo signal. Attenuation coefficient determination at S772 is substantially similar to attenuation coefficient determination at S552 of FIG. 5 except where described differently.

At S774, the extracting section or a sub-section thereof estimates a backscatter coefficient of the surface from the echo signal. Backscatter coefficient estimation at S774 is substantially similar to backscatter coefficient estimation at S554 of FIG. 5 except where described differently.

At S776, the extracting section or a sub-section thereof applies a neural network to the echo signal to obtain a feature vector. Neural network application at S776 is substantially similar to neural network application at S556 of FIG. 5 except where described differently.

In at least some embodiments, the extracting section performs the operations at S770, S772, S774, and S776 to extract the feature values from the echo signal. In at least some embodiments, extracting the plurality of feature values from the echo signal includes: estimating a depth of the surface from the echo signal, determining an attenuation coefficient of the surface from the echo signal, estimating a backscatter coefficient of the surface from the echo signal, and applying a neural network to the echo signal to obtain a feature vector, the neural network trained with a classification layer to classify echo signal samples as live or not live.

At S778, the extracting section or a sub-section thereof merges the feature values. In at least some embodiments, the extracting section merges the estimated depth from S772, the determined attenuation coefficient from S774, the estimated backscatter coefficient from S774, and the feature vector from S776. In at least some embodiments, the extracting section concatenates the feature values into a single string, which increases the features included in the feature vector.

At S779, the applying section or a sub-section thereof applies a classifier to the merged feature values. In at least some embodiments, applying the classifier includes applying the classifier to the feature vector, the depth, the attenuation coefficient, and the backscatter coefficient, the classifier trained to classify echo signal extracted feature value samples as live or not live. In at least some embodiments, the classifier is applied to a concatenation of the feature values. In at least some embodiments, the classifier is an anomaly detection classifier. In at least some embodiments, the classifier is trained to output binary values upon application to merged feature values, the binary value representing whether the echo signal is consistent with a live human face. In at least some embodiments, the classifier undergoes a training process similar to the training process of FIG. 6, except the classifier training process includes training the neural network with the classifier using a plurality of echo signal extracted feature value samples, each echo signal extracted feature value sample labeled live or not live, wherein the training includes adjusting parameters of the neural network and the classifier based on a comparison of output class with corresponding labels.

FIG. 8 is a schematic diagram of a third feature value extraction and classifier application process, according to at least some embodiments of the subject disclosure. The diagram includes an echo signal 892, a depth estimating section 884A, an attenuation coefficient determining section 884B, a backscatter coefficient estimating section 884C, a convolutional neural network 894A, a classifier 894B, a depth estimation 896A, an attenuation coefficient determination 896B, a backscatter coefficient estimation 896C, a feature vector 896D, and a class 898.

Echo signal 892 is input to depth estimating section 884A, attenuation coefficient determining section 884B, backscatter coefficient estimating section 884C, and convolutional neural network 894A. In response to input of echo signal 892, depth estimating section 884A outputs depth estimation 896A, attenuation coefficient determining section 884B outputs attenuation coefficient determination 896B, backscatter coefficient estimating section 884C outputs backscatter coefficient estimation 896C, and convolutional neural network 894A outputs feature vector 896D.

In at least some embodiments, depth estimation 896A, attenuation coefficient determination 896B, and backscatter coefficient estimation 896C are real values without normalization or comparison with thresholds. In at least some embodiments, depth estimation 896A, attenuation coefficient determination 896B, and backscatter coefficient estimation 896C are normalized values. In at least some embodiments, depth estimation 896A, attenuation coefficient determination 896B, and backscatter coefficient estimation 896C are binary values representing a result of comparison with respective threshold values, such as the threshold values described with respect to FIG. 5.

Depth estimation 896A, attenuation coefficient determination 896B, backscatter coefficient estimation 896C, and feature vector 896D are combined to form input to classifier 894B. In at least some embodiments, depth estimation 896A, attenuation coefficient determination 896B, backscatter coefficient estimation 896C, and feature vector 896D are concatenated into a single string of feature values for input to classifier 894B.

Classifier 894B is trained to output class 898 in response to input of the feature values. Class 898 represents whether the surface associated with the echo signal is consistent with a live human face or not.

FIG. 9 is a block diagram of a hardware configuration for face liveness detection, according to at least some embodiments of the subject disclosure.

The exemplary hardware configuration includes apparatus 900, which interacts with microphones 910/911, a speaker 913, a camera 915, and a tactile input 919, and communicates with network 907. In at least some embodiments, apparatus 900 is integrated with microphones 910/911, speaker 913, camera 915, and tactile input 919. In at least some embodiments, apparatus 900 is a computer system that executes computer-readable instructions to perform operations for physical network function device access.

Apparatus 900 includes a controller 902, a storage unit 904, a communication interface 906, and an input/output interface 908. In at least some embodiments, controller 902 includes a processor or programmable circuitry executing instructions to cause the processor or programmable circuitry to perform operations according to the instructions. In at least some embodiments, controller 902 includes analog or digital programmable circuitry, or any combination thereof. In at least some embodiments, controller 902 includes physically separated storage or circuitry that interacts through communication. In at least some embodiments, storage unit 904 includes a non-volatile computer-readable medium capable of storing executable and non-executable data for access by controller 902 during execution of the instructions. Communication interface 906 transmits and receives data from network 907. Input/output interface 908 connects to various input and output units, such as microphones 910/911, speaker 913, camera 915, and tactile input 919, via a parallel port, a serial port, a keyboard port, a mouse port, a monitor port, and the like to exchange information.

Controller 902 includes emitting section 980, obtaining section 982, extracting section 984, and applying section 986. Storage unit 904 includes detections 990, echo signals 992, extracted features 994, neural network parameters 996, and classification results 998.

Emitting section 980 is the circuitry or instructions of controller 902 configured to cause emission of liveness detecting sound signals. In at least some embodiments, emitting section 980 is configured to emit an ultra-high frequency (UHF) sound signal through a speaker. In at least some embodiments, emitting section 980 includes sub-sections for performing additional functions, as described in the foregoing flow charts. In at least some embodiments, such sub-sections are referred to by a name associated with a corresponding function.

Obtaining section 982 is the circuitry or instructions of controller 902 configured to obtain echo signals. In at least some embodiments, obtaining section 982 is configured to obtain an echo signal by detecting reflections of the UHF sound signal off of a surface with a plurality of sound detectors. In at least some embodiments, obtaining section 982 records information to storage unit 904, such as detections 990 and echo signals 992. In at least some embodiments, obtaining section 982 includes sub-sections for performing additional functions, as described in the foregoing flow charts. In at least some embodiments, such sub-sections are referred to by a name associated with a corresponding function.

Extracting section 984 is the circuitry or instructions of controller 902 configured to extract feature values. In at least some embodiments, extracting section 984 is configured to extract a plurality of feature values from the echo signal. In at least some embodiments, extracting section 984 utilizes information from storage unit 904, such as echo signals 992 and neural network parameters 996, and records information to storage unit 904, such as extracted features 994. In at least some embodiments, extracting section 984 includes sub-sections for performing additional functions, as described in the foregoing flow charts. In at least some embodiments, such sub-sections are referred to by a name associated with a corresponding function.

Applying section 986 is the circuitry or instructions of controller 902 configured to apply classifiers to feature values. In at least some embodiments, applying section 986 is configured to apply a classifier to the plurality of feature values to determine whether the surface is a live face. In at least some embodiments, applying section 986 utilizes information from storage unit 904, such as extracted features 994 and neural network parameters 996, and records information in storage unit 904, such as classification results 998. In at least some embodiments, extracting section 984 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user’s computer, partly on the user’s computer, as a stand-alone software package, partly on the user’s computer and partly on a remote computer or entirely on the remote computer or server. In at least some embodiments, in the latter scenario, the remote computer is connected to the user’s computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiment of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the subject disclosure, face liveness is detected by emitting an ultra-high frequency (UHF) sound signal through a speaker, obtaining an echo signal by detecting reflections of the UHF sound signal off of a surface with a plurality of sound detectors, extracting a plurality of feature values from the echo signal, and applying a classifier to the plurality of feature values to determine whether the surface is a live face.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
emitting an ultra-high frequency (UHF) sound signal through a speaker;
obtaining an echo signal by detecting reflections of the UHF sound signal off of a surface with a plurality of sound detectors;
extracting a plurality of feature values from the echo signal; and
applying a classifier to the plurality of feature values to determine whether the surface is a live face.

2. The computer-readable medium of claim 1, wherein
extracting the plurality of feature values from the echo signal includes applying a neural network to the echo signal to obtain a feature vector, the neural network trained with a classification layer to classify echo signal samples as live or not live, and
applying the classifier includes applying the classification layer to the feature vector.

3. The computer-readable medium of claim 2, further comprising
training the neural network with the classification layer using a plurality of echo signals samples, each echo signal sample labeled live or not live;
wherein the training includes adjusting parameters of the neural network and the classification layer based on a comparison of output class with corresponding labels.

4. The computer-readable medium of claim 1, wherein
extracting the plurality of feature values from the echo signal includes:
estimating a depth of the surface from the echo signal,
determining an attenuation coefficient of the surface from the echo signal,
estimating a backscatter coefficient of the surface from the echo signal, and
applying a neural network to the echo signal to obtain a feature vector, the neural network trained with a classification layer to classify echo signal samples as live or not live, and
applying the classifier includes applying the classifier to the feature vector, the depth, the attenuation coefficient, and the backscatter coefficient, the classifier trained to classify echo signal extracted feature value samples as live or not live.

5. The computer-readable medium of claim 4, further comprising
training the neural network with the classifier using a plurality of echo signal extracted feature value samples, each echo signal extracted feature value sample labeled live or not live;
wherein the training includes adjusting parameters of the neural network and the classifier based on a comparison of output class with corresponding labels.

6. The computer-readable medium of claim 1, wherein
extracting the plurality of feature values from the echo signal includes estimating a depth of the surface from the echo signal, and
applying the classifier includes comparing the depth to a threshold depth value.

7. The computer-readable medium of claim 1, wherein
extracting the plurality of feature values from the echo signal includes determining a attenuation coefficient of the surface from the echo signal, and
applying the classifier includes comparing the attenuation coefficient to a threshold attenuation coefficient range.

8. The computer-readable medium of claim 1, wherein
extracting the plurality of feature values from the echo signal includes estimating a backscatter coefficient of the surface from the echo signal, and
applying the classifier includes comparing the backscatter coefficient to a threshold backscatter coefficient range.

9. The computer-readable medium of claim 1, wherein the plurality of sound detectors includes a first sound detector oriented in a first direction and a second sound detector oriented in a second direction.

10. The computer-readable medium of claim 1, wherein
the plurality of sound detectors includes a plurality of microphones, and
the speaker and the plurality of microphones are included in a handheld device.

11. The computer-readable medium of claim 10, wherein
the handheld device further includes a camera, and
the UHF sound signal is emitted in response to detecting a face with the camera.

12. The computer-readable medium of claim 1, wherein the UHF sound signal is 18-22 kHz.

13. The computer-readable medium of claim 1, wherein the UHF sound signal is substantially inaudible.

14. The computer-readable medium of claim 1, wherein the UHF sound signal includes a sinusoidal wave and a sawtooth wave.

15. The computer-readable medium of claim 1, further comprising
imaging the surface with a camera to obtain a surface image;
analyzing the surface image to determine whether the surface is a face;
identifying the surface by analyzing the surface image in response to determining that the surface is a face and determining that the surface is a live face; and
granting access to at least one of a device or a service in response to identifying the surface as an authorized user.

16. The computer-readable medium of claim 1, wherein obtaining the echo signal includes
isolating the reflections of the UHF sound signal with a time filter, and
removing noise from the reflections of the UHF sound signal by comparing detections of each sound detector of the plurality of sound detectors and the emitted UHF sound signal.

17. A method comprising:
emitting an ultra-high frequency (UHF) sound signal through a speaker;
obtaining an echo signal by detecting reflections of the UHF sound signal off of a surface with a plurality of sound detectors;
extracting a plurality of feature values from the echo signal; and
applying a classifier to the plurality of feature values to determine whether the surface is a live face.

18. The method of claim 17, wherein
extracting the plurality of feature values from the echo signal includes applying a neural network to the echo signal to obtain a feature vector, the neural network trained with a classification layer to classify echo signal samples as live or not live, and
applying the classifier includes applying the classification layer to the feature vector.

19. An apparatus comprising:
a plurality of sound detectors;
a speaker; and
a controller including circuitry configured to:
emit an ultra-high frequency (UHF) sound signal through the speaker,
obtain an echo signal by detecting reflections of the UHF sound signal off of a surface with a plurality of sound detectors,
extract a plurality of feature values from the echo signal, and
apply a classifier to the plurality of feature values to determine whether the surface is a live face.

20. The apparatus of claim 19, wherein
the circuitry configured to extract the plurality of feature values from the echo signal is further configured to apply a neural network to the echo signal to obtain a feature vector, the neural network trained with a classification layer to classify echo signal samples as live or not live, and
the circuitry configured to apply the classifier is further configured to apply the classification layer to the feature vector.
